(19) United States
(12) Patent Application Publication
(10) Pub. No.: US 2011/0055373 A1
(43) Pub. Date: Mar. 3, 2011

(54) SERVICE IDENTIFICATION FOR RESOURCES IN A COMPUTING ENVIRONMENT

(75) Inventors: Jonathan Bnayahu, Haifa (IL); Mordechai Nisenson, Haifa (IL); Yahalomit Simionovici, Haifa (IL)

(73) Assignee: International Business Machines Corporation, Armonk, NY (US)

(21) Appl. No.: 12/550,377

(22) Filed: Aug. 30, 2009

(51) Int. Cl. G06F 3/00; G06F 17/30; G06F 15/173

(52) U.S. Cl. 709/224; 710/17; 710/5; 709/206; 707/E17.014

(57) ABSTRACT

A method for identifying computational services performed by one or more computing resources is provided. The method comprises analyzing digital data associated with the computing resources to identify similarities between the digital data; grouping sets of digital data into one or more clusters according to similarities identified between the digital data; and generating a description for the one or more clusters to describe at least one computational service associated with a set of digital data grouped in the one or more clusters.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of the claimed subject matter to material associated with such marks.

### TECHNICAL FIELD

The claimed subject matter relates to identifying services of a computing system based on resources of the computing system.

### BACKGROUND

Due to the advancements in communications and information technology, distributed computing environments are becoming highly desirable and more feasible. A distributed environment or infrastructure provides for a smoother transition in rapidly changing business environments. Accordingly, the design of many computing and processing infrastructures is shifting towards a service-oriented architecture (SOA) where the business goals and resources of an organization can be better supported and deployed.

An SOA framework, typically, allows for a set of interoperable services and resources to be deployed as a part of a distributed environment. Advantageously, different services and resources may be introduced as an integral part of the SOA framework so long as each service maintains a communication interface that is compatible with a predefined communication protocol of the SOA.

The underlying functionalities provided by a service or resource may be managed in an abstract manner by ensuring that each added service or resource complies with the predefined communication protocol of the underlying SOA. Added levels of abstraction in an SAO framework also allow developers to more freely design a service or resource by, for example, using one or more programming languages (e.g., Java, C#, C, C++, COBOL, etc.) of their choice.

The successful implementation of an SOA framework typically requires additional investment in purchasing new resources and tools (i.e., hardware and software) that are specifically compatible with the SOA framework. Thus, commitment to a substantial budget associated with redesigning the pre-existing resources and tools may be necessary to ensure that pre-existing services associated with such resources and tools remain operational within the new SOA framework.

### SUMMARY

The present disclosure is directed to systems and corresponding methods that identify services of one or more computing systems based on resources of the computing systems.

For purposes of summarizing, certain aspects, advantages, and novel features have been described herein. It is to be understood that not all such advantages may be achieved in accordance with any one particular embodiment. Thus, the claimed subject matter may be embodied or carried out in a manner that achieves or optimizes one advantage or group of advantages without achieving all advantages as may be taught or suggested herein.

In accordance with one embodiment, a method for identifying services associated with one or more computing resources of a computing system is provided. The method comprises identifying digital data that is associated with the one or more computing resources. The method analyzes the digital data to identify similarities between the digital data. Different sets of digital data may be grouped into one or more clusters according to similarities identified between the digital data. Additional digital data may be used to refine or modify the cluster groupings.

A description for the respective clusters may be generated to define at least one computational service that is associated with the digital data grouped in each respective cluster. In some embodiments, a service is defined for a set of clusters according to similarities identified between descriptions for the set of clusters. Depending on implementation, analyzing, grouping, generating, and defining may be performed by a computing system, desirably, independent of human intervention.

A set of conditions may be selected to identify similarities between the digital data when analyzing the digital data. The set of conditions may represent a clustering algorithm that is selected from among several clustering algorithms.

The digital data, in one embodiment, represents different forms of data such as program code, documentation, or test data. Accordingly, a cluster may include a type of digital data, such as program code from different files. Alternatively, a cluster may include different types of digital data, such as program code and documentation. In some embodiments, one type of digital data (e.g., documentation) may be used to refine clusters that include groupings of digital data of another type (e.g., program code). In order to group the digital data into the different clusters, a set of conditions are selected to identify the similarities based on the identified type of the digital data.

The digital data may include multiple data elements. For instance, program code may include different function calls and documentation may include different section headers, where each function call or section header represents a data element of the digital data. In some embodiments, the digital data is grouped into the clusters based on conceptual or structured similarities, whether text or workload dependent, based on the data elements.

A summarization algorithm may be selected to generate the summary descriptions for the clusters. The description desirably specifies functionality of the corresponding cluster. A cluster description may be processed to identify at least one service for the digital data that is associated with a resource of the computing system. Additionally, two or more cluster descriptions may be processed to identify a single similar service.

System administrators or system developers may utilize the descriptions to understand system functionality or as a basis for integrating the identified services of the computer system into a distributed computing environment. The distributed computing environment includes several resources inter-operating through a common communication interface. Therefore, in some embodiments, a communication interface is defined for and applied to the analyzed resource. The communication interface enables the corresponding identified service of the resource to inter-operate with services performed by other resources of the distributed computing environment without requiring modifications to the underlying functionality of the resource.

A set of constraints may be received that specifies a threshold for determining the similarity between at least two generated descriptions before processing the generated descriptions. In some embodiments, a set of constraints may be provided to specify a threshold for grouping a data element to a particular cluster.

In accordance with another embodiment, a system comprising one or more logic units is provided. The one or more logic units are configured to perform the functions and operations associated with the above-disclosed methods. In accordance with yet another embodiment, a computer program product comprising a computer useable medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The claimed subject matter is not, however, limited to any particular embodiment disclosed.

### BRIEF DESCRIPTION OF THE DRAWINGS

Embodiments of the claimed subject matter are understood by referring to the figures in the attached drawings, as provided below.

FIG. 1 represents a computing system with a service identification system that identifies services associated with resources of the computing system, in accordance with one embodiment.

FIG. 2 illustrates exemplary functional modules of the service identification system for performing service identification or summarization, in accordance with one embodiment.

FIG. 3 illustrates a flow diagram representing a process for identifying and summarizing services of a target resource in a computing environment, in accordance with one embodiment.

FIG. 4 illustrates a flow diagram representing a process for identifying and summarizing services of a target resource based on multiple clustering algorithms and user specified constraints, in accordance with one embodiment.

FIG. 5 represents an exemplary embodiment in which digital data is associated with a target resource with services that are desirably identified automatically and in an unsupervised manner.

FIG. 6 illustrates an exemplary description produced by an exemplary embodiment.

FIG. 7 conceptually illustrates how the descriptions generated by an exemplary embodiment facilitate integration of a resource (e.g., a software application) into a distributed computing environment.

FIGS. 8 and 9 are block diagrams of hardware and software environments in which a system may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXEMPLARY EMBODIMENTS

In the following, numerous specific details are set forth to provide a thorough description of various embodiments of the claimed subject matter. Certain embodiments may be practiced without these specific details or with some variations in detail. In some instances, certain features are described in less detail so as not to obscure other aspects of the disclosed embodiments. The level of detail associated with each of the elements or features should not be construed to qualify the novelty or importance of one feature over the others.

Systems and corresponding methods are provided for identifying services of a resource of a computing system based on digital data associated with the resource. In an exemplary embodiment, the resource is a software application that includes computer code or instructions executed by a processor of the computing system. The resource may be one functional component of a larger software application that is comprised of multiple different resources of the computing system. Each resource may perform a single service or may inter-operate with other resources to perform one or more services.

In one embodiment, there is a one to one relationship between the resources and the provided services. Such service identification provides developers and system administrators with the ability to rapidly identify the proper resource that is to be modified when the developer or system administrator desires to alter the functionality of the associated service.

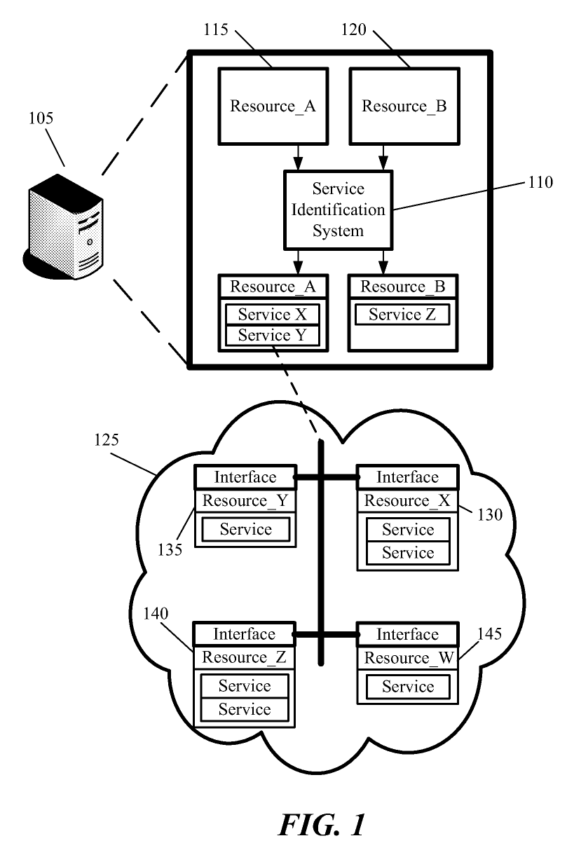

FIG. 1 represents a computing system 105 with a service identification system 110 that identifies services associated with resources 115 and 120 of the computing system 105, in accordance with one embodiment. The service identification system 110 analyzes the digital data associated with the resources 115 and 120. An analysis of the digital data helps identify or summarize the services associated with the resources 115 and 120. Such identification or summarization desirably allows a user to, for example, view the services associated with the resources 115 and 120 without the user having to manually analyze the digital data associated with each of the resources 115 and 120.

In this manner, a specific resource providing a specific service may be identified and modified to enhance or alter in other ways the service functionality. For example, a modified communication interface may be added to the service to enable inter-operability with other services of a distributed computing environment 125 to which computing system 105 may be coupled to (see FIG. 1).

The distributed computing environment 125 may comprise one or more computing systems. The computing systems include resources 130, 135, 140, and 145 which provide a set of inter-operable services for the distributed computing environment 125. The resources in the distributed computing environment 125 adhere to a common interface specification defined for inter-operability within the distributed computing environment 125. This common interface allows each of the services associated with the resources 130, 135, 140, and 145 to exchange data and communicate with one another.

Functionality for the distributed computing environment 125 may be extended by integrating the pre-existing services of the computing system 105 to the distributed computing environment 125. The services provided by resources 115 and 120 may not adhere to the common interface specification of the distributed computing environment 125. Through the service identification system 110, system administrators or developers are able to identify these services and the location of each of the services within the resources 115 and 120. A determination may then be made as to whether or not the services should be integrated into the distributed computing environment 125 by modifying interfaces of one or more of the resources so that the interfaces adhere to the environment's communication protocol or interface.

In some embodiments, the service identification system 110 is a software application that locally executes on the same computing system 120 as the target resources 115 and 120. It is noteworthy, however, that the service identification system 110 may be executed on a computing system that is remotely coupled to the computing system 120. For example, the service identification system 110 may be hosted by a computing system of the distributed computing environment 125.

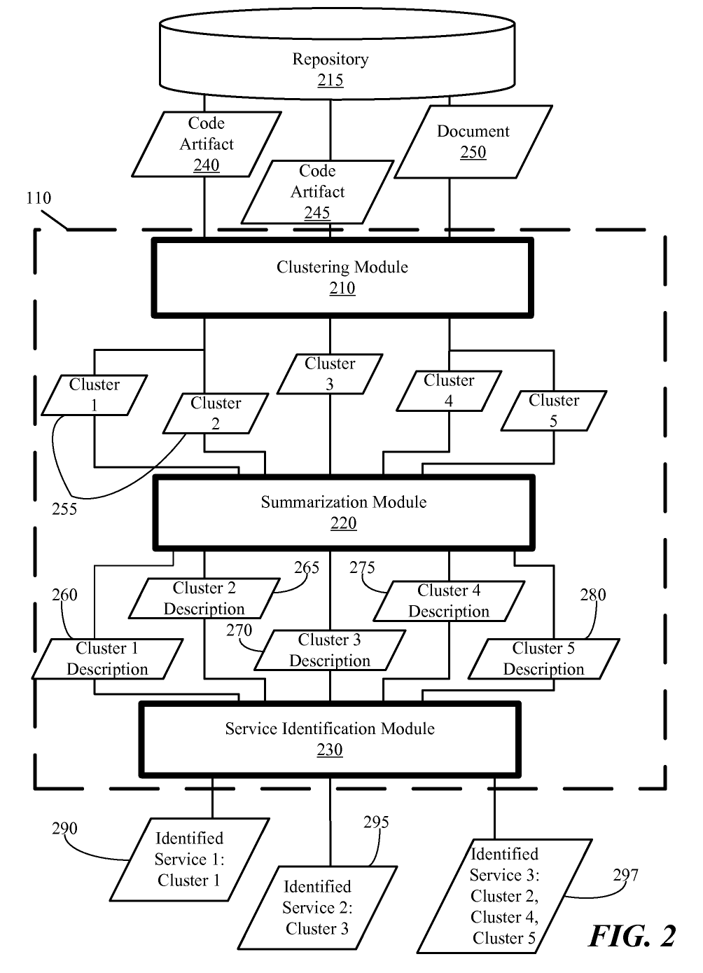

FIG. 2 illustrates exemplary functional modules of the service identification system 110 for performing service identification or summarization. As shown, system 110 may comprise a clustering module 210, a summarization module 220, and a service identification module 230. The clustering module 210 interfaces with a repository 215 to acquire the digital data associated with one or more resources. A user may populate the repository 215 with the digital data or with information that identifies the digital data associated with a target resource.

The repository 215 may be implemented over a set of contiguous or distributed storage systems defined over one or more storage media (e.g., magnetic disk, flash memory, compact disc, etc.). The repository 215 may also comprises logical files or directories implemented on the storage media. The repository 215, depending on implementation, may be accessible through an operating system, database application, system calls, or network interface of a computing system or other electronic processing device.

The digital data may include digitally stored files or digital objects (e.g., database tables, database records, containers, data structures, etc.). Each piece of digital data includes one or more data elements. For example, the digital data associated with a resource includes one or more lines of program code associated with one or more files related to that resource. Alternatively, the digital data may include one or more lines associated with one or more of the following: documentation material, requirement material, testing material, or other information associated with the resource.

The program code may include high level programming code (e.g., C, C#, C++, JAVA, etc.), object code, or binary code that specify the instructions performed by the resource. In some embodiments, the program code comprises comments that may not be executable, but that are nevertheless incorporated within the program code. Documentation may include user manuals, development manuals, marketing materials, and other digitally stored documentation relating to the program code.

Referring to FIG. 2, the clustering module 210 may be able to access digital data 240, 245, and 250. Digital data 240 and digital data 245 represent code artifacts. Each code artifact may include multiple data elements from one or more resource files. In some embodiments, the data elements may include segments of code (e.g., lines of code, function calls, comments, individual source files), or individual words, sentences, and paragraphs associated with the code artifacts. Additional data elements may include function signatures, testing information (e.g., workload patterns or data traces), requirements specifications, accessed resources (e.g., database tables, files, uniform resource locator addresses) or other documentation as represented by digital data 250.

In some embodiments, the clustering module 210 comprises logic to select a clustering algorithm from a storage medium configured for storing multiple different clustering algorithms. In some embodiments, the clustering module 210 applies different clustering algorithms to the various digital data (e.g., code artifact 240, code artifact 245, and document 250). The storage medium may be a local component of the computing system on which the service identification system 110 executes or may be remotely coupled to the computing system through a communication network. The clustering module 210 identifies similarities within the digital data and parses each similar observation into a different cluster. In some embodiments, the clustering module 210 identifies data elements associated with a similar service and groups these data elements into a common cluster.

Referring again to FIG. 2, clusters 255 represent a collection of clusters (e.g., clusters 1 through 5) produced by the clustering module 210. In some embodiments, each cluster has a one to one mapping correspondence with an identified service. Additionally, multiple clusters of different digital data types may map to the same service. It should also be evident that in some embodiments there is a many-to-one or one-to-many mapping correspondence between each cluster and a service.

Clusters 255 may be provided to the summarization module 220. The summarization module 220 applies a summarization algorithm to each of the clusters 1 through 5, for example. The summarization module 220 generates description files 260, 265, 270, 275, and 280 based on the clusters 255. Each description file provides a description for a corresponding cluster associated with the one or more resources associated with the digital data.

In some embodiments, the description files 260, 265, 270, 275, and 280 may be provided to the service identification module 230. Based on the description files, the service identification module 230 produces service identification output files 290, 295, and 297. Each service identification output file identifies a service associated with the digital data. The service identification module 230 may generate a unified service identification output file (e.g., service identification output file 297) from two or more description files (e.g., 265, 275, and 280) associated with two or more clusters, when the clusters identify similar services for different types of digital data (e.g., program code, documentation, reference materials, etc.).

The service identification module 230 may also generate a unified service identification file for two or more clusters when the clusters identify different services but where the services satisfy a predefined threshold (e.g., one or more similarity factors). Accordingly, a service identification output file may define a service that is associated with a single cluster (e.g., service identification file 290 identifying a service associated with cluster 1) or may define a service that is associated with multiple clusters (e.g., service identification output file 297 identifying a service associated with clusters 2, 4, and 5).

The clustering module 210, the summarization module 220, and the service identification module 230 may be software modules executable on a computing system, such as computing system 105 shown in FIG. 1. It is also worth noting that the clustering module 210, the summarization module 220, and the service identification module 230 may be embedded as hardware devices within a computing system. Furthermore, it is noteworthy that even though the clustering module 210, summarization module 220, and the service identification module 230 are depicted as three separate modules, the functionality of these modules may be embodied in additional or fewer modules.

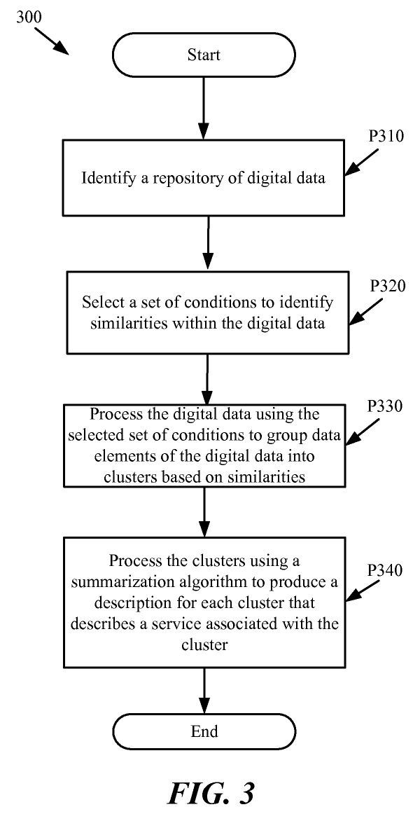

Referring to FIGS. 1 through 3, a process 300 is performed for identifying and summarizing services of a target resource (e.g., resource A) in a computing system, in accordance with one embodiment. In some embodiments, the process 300 is performed by the clustering module 210, the summarization module 220, and the service identification module 230. Depending on implementation, the target resource may be a newly introduced resource or a pre-existing resource of the computing system. For example, a target resource may include a software application that provides one or more services.

In accordance with one embodiment, the clustering module 210 accesses the repository 215 to obtain digital data to analyze and process (P310). The repository 215 includes the digital data associated with the target resource (not shown in FIG. 2). In an exemplary embodiment, the identified digital data comprises code artifacts that represent program code from one or more files associated with the resource.

To process the identified digital data within the repository 215, the clustering module 210 may select a set of conditions to identify similarities within the digital data (P320). In some embodiments, the set of conditions represents a clustering algorithm. A clustering algorithm is an algorithm that defines (1) a set of observations as conditions for identifying similarity among distinct data elements in the identified digital data and (2) a scheme for partitioning the observations into one or more groups.

In some embodiments, the clustering algorithm specifies a soft partitioning of the digital data whereby a probability distribution is applied to each digital data artifact or to each data element of a digital data artifact. Specifically, a probability is assigned to each piece of digital data or data element to designate the cluster to which the piece of data belongs. That is, the clustering algorithm is used to analyze the digital data and to identify similar categorization within the digital data.

Accordingly, the clustering module 210, in one embodiment, processes the digital data using the selected set of conditions in order to group each data element that satisfies an observation condition into a cluster (P330). The processing and grouping is desirably performed independent of human intervention.

A cluster may be configured to represent an identified service associated with a resource that is included within the repository. For example, identified digital data (e.g., artifact) associated with a resource may include a sales service, an inventory service, and a shipping service. Another digital data associated with a second resource may include the sales services and the shipping service but not the inventory service, for example.

In the above examples, the clustering module 210 may use a clustering algorithm to group the sales service of the two separately identified digital data into a first cluster, the inventory service into a second cluster, and the shipping service into a third cluster. In this manner, each cluster identifies a service (e.g., sales, inventory, and shipping) within the digital data associated with separate and distinct resources. It should be evident that a service may also be identified as two or more clusters with a threshold set of similarities.

Depending on implementation, different clustering algorithms may perform different categorizations and therefore yield different groupings (e.g., different sets of clusters). In some exemplary embodiments, a clustering algorithm may be implemented that takes into account textual similarity. A textual clustering algorithm implemented by A. K. Jain, M. N. Murty and P. J. Flynn as disclosed in publication entitled “Data Clustering: A Review,” ACM Comp. Surv., 1999” may be utilized in one or more exemplary embodiments.

In some embodiments, the clustering module 210 selects a clustering algorithm that takes into account other measures such as structural and workload similarities. Structural similarity refers to, for example, a degree or a factor of similarity between various data elements (e.g., data objects, variables, function calls, etc.). For instance, a private data object that is locally accessible to a resource is structurally different than a public data object that is globally accessible to all resources in a distributed computing environment.

Structural similarity may also account for how data elements fit into a layering division of the system. For instance, a similarity measure would assign a similarity value of one for two data elements (e.g., functions, classes, etc.) that appear in the same layer of the program hierarchy and a similarity value of zero for data elements that do not appear in the same layer.

Workload similarity relates to data elements that access the same or similar information at runtime or dynamically. For example, two data elements (e.g., function calls) that access the same database table at runtime have a higher workload similarity than two data elements that access unique and unrelated database tables.

For example, comparing what functions were called at a specific point during runtime. It is noteworthy that, depending on implementation, the clustering module in some embodiments may utilize different clustering algorithms for the proper grouping of digital data (e.g., data elements) into one or more clusters.

The data elements in each cluster may be used to identify the service associated with the corresponding one or more resources in a computing environment. In some embodiments, the clusters retain raw information that may be further processed by the summarization module 220. The summarization module 220 in one implementation invokes a summarization algorithm to generate the description for each cluster (P340).

Depending on implementation, the generated description may include information (e.g., text) that is used by the service identification module 230 to define one or more services associated with resources grouped in a cluster in human or machine understandable format. Exemplary embodiments may utilize a summarization algorithm implemented by Rada Mihalcea and Paul Tarau as disclosed in a document entitled “An Algorithm for Language Independent Single and Multiple Document Summarization” in Proceedings of the International Joint Conference on Natural Language Processing (IJCNLP), Korea 2005. It is noteworthy that other summarization algorithms may be utilized in different embodiments.

The generated descriptions provide for added efficiency in identification of services associated with one or more resources. The above descriptions are generated, desirably, independent of human intervention. The service identification module 230 processes the descriptions to identify the corresponding services, thereby eliminating the need for an exhaustive review of the digital data associated with the one or more resources by a human operator. As such, the time consuming exercise of analyzing hundreds or thousands of lines of programming code, documentation, and other digital data associated with the resource in order to identify the services associated with the digital data is automatically performed by the proposed system.

A description of the functionality of the computing system and the respective resource for each functionality as implemented within the computing system may thus be determined. The resources may then be enhanced or otherwise modified per system requirements. For example, if the identified services are deemed valuable to a distributed computing environment, a resource interface may be implemented or modified such that the service provided by the resource may be provided to other components of the distributed computing environment.

In other words, an interface may be implemented for the identified services so that a target resource may inter-operate or communicate with other services provided in the distributed computing environment without reprogramming or modifying the underlying functionality of the target resource.

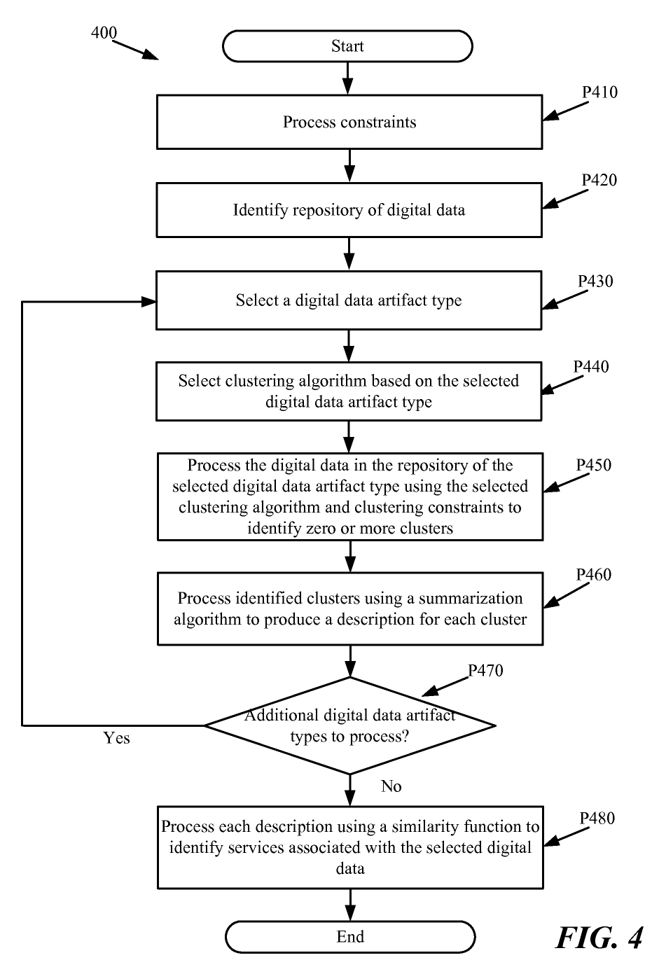

Referring to FIG. 4, a process 400 may be performed for identifying and summarizing services of a target resource based on multiple clustering algorithms and user specified constraints, in accordance with one embodiment. In some embodiments, the clustering module, the summarization module, and the service identification module perform the process 400.

A set of constraints (e.g., user defined conditions) may be provided to and processed by the clustering module 210, the summarization module 220, the service identification module 230, or any combination thereof depending on the nature of the constraints (P410). In some embodiments, the constraints include clustering constraints, similarity constraints, or both. User specified clustering constraints may alter the manner in which a clustering algorithm processes or generates clusters.

The user specified similarity constraints may also alter the manner in which a summarization algorithm generates the descriptions for the clusters. The clustering constraints and similarity constraints are described in greater detail below. A repository including digital data associated with the resource is identified (P420). The repository may include digital data such as program code, application documentation, requirements, testing materials, and other forms of digital data.

The clustering module selects a digital data artifact type from the repository (P430). Depending on the type of digital data artifact that is selected (e.g., program code or application documentation), the clustering module selects a particular clustering algorithm to perform the cluster analysis over the selected digital data artifact (P440). For example, the clustering module selects a clustering algorithm that measures textual similarity for digital data of a type that includes application documentation and the clustering module selects a clustering algorithm that measures workload similarity for digital data of a type that includes program code.

Using the selected clustering algorithm, the clustering module performs the cluster analysis on digital data in the repository of the selected digital data artifact type (P450). In some embodiments, the performance of the clustering module, and more the performance of the clustering algorithm, is modified as described below when clustering constraints are processed at P410. In some embodiments, the clustering constraints are soft constraints whereby the strength of the constraint is measured from a scale of zero to one. Such a constraint defines a threshold for guiding the clustering algorithm's processing of the constraints.

For example, a constraint value may affect how the clustering module using the clustering algorithm determines whether a data element is sufficiently similar to other data elements and whether the data element is to be grouped with the other data elements in a certain cluster. More specifically, a clustering constraint may specify that two data elements are to be grouped in a specific cluster or that a predefined similarity score be assigned between two data elements.

In the following, a process for clustering constraints is provided by way of example. It is noteworthy that the exemplary embodiments provided here shall not be construed as to limit the scope of the claims to such examples. For example, a clustering constraint value of 0.3 may cause the clustering module using a textual similarity clustering algorithm to group the phrase “GUI interface controls” with the phrase “GUI interface layout” into a one cluster.

In this example, the clustering value of 0.3 may require that each phrase have at least one similar term (e.g., “GUI” or “interface”) in order to be grouped into the same cluster. However, a clustering constraint value of one causes the clustering module using the clustering algorithm to group these same textual phrases into separate clusters since the clustering constraint value of one imposes a more stringent observation requirement whereby all three terms of each phrase must match.

In some embodiments, the clustering constraints provide guiding information. Some such clustering constraints cause the clustering module using the clustering algorithm to target one or more services. Accordingly, the clustering module yields fewer more focused clusters that contain those services as defined by the user through the specified clustering constraints. For example, code artifacts may contain services for arithmetic addition, subtraction, and multiplication. However, clustering constraints may guide the clustering module to identify the addition and subtraction services and to ignore the multiplication service, for example.

Referring back to FIG. 4, after grouping the data elements of the digital data artifacts into the clusters, the summarization algorithm processes the resulting clusters with a summarization algorithm to produce the description files describing the clusters (P460).

The clustering module may be configured to select additional digital data artifact types from the repository, in response to determining that additional digital data artifact types remain within the identified repository for analysis (P470). When additional digital data artifact types remain, the clustering module selects the next digital data artifact type (P430), selects a clustering algorithm based on the selected digital data artifact type (P440), performs the cluster analysis on the digital data of the selected type (P450), and processes the clusters using the summarization algorithm to produce the description for each cluster (P460).

When no additional digital data artifact types remain to be processed in the repository, the service identification module processes the description files to define the one or more services associated with the digital data (P480). In some embodiments, the service identification module identifies commonality within the generated cluster descriptions thereby associating two or more clusters with a single service. In one implementation, the process identifies commonality using a similarity function between descriptions.

In some embodiments, similarity constraints, when specified at P410, alter how the similarity function operates. For example, the similarity constraints control how close the similarities between two clusters or two descriptions must be before they are combined and defined as a single service. After the similarity function completes executing, the process ends.

By analyzing the unified descriptions, the services provided by a targeted resource may be assessed more efficiently. Furthermore, advantageously, the process 400 may be performed in an unsupervised manner (e.g., desirably without human intervention). In some embodiments, the clustering constraints may be modified after an initial processing pass of the process 400 to further refine the clusters that the clustering modules generates using the one or more clustering algorithms. Users may also modify the similarity constraints to further refine the grouping of clusters or cluster descriptions into identified services.

With reference to FIG. 4, it is noteworthy that the summarization at P460 need not occur immediately after performing the clustering at P450. In some embodiments, the summarization module generates the descriptions for clusters after digital data artifacts in the repository have been processed by the clustering module. In other words, the summarization module may batch process a group of clusters rather than individually process each cluster as they are generated by the clustering module.

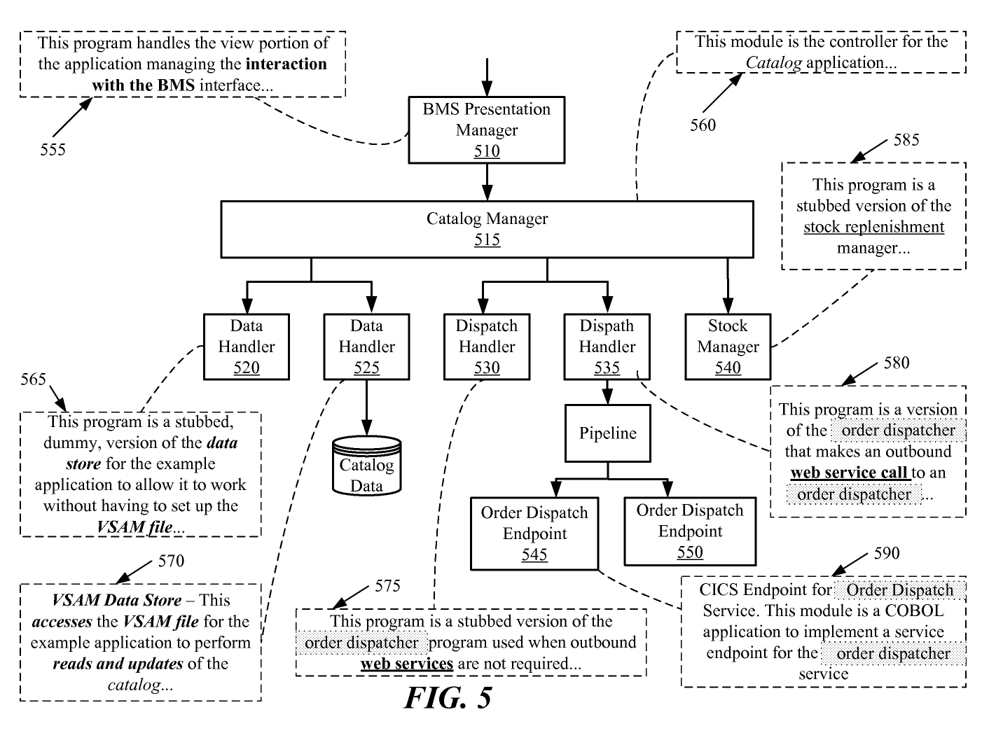

FIG. 5 illustrates exemplary digital data that may be associated with a target resource, in accordance with one embodiment. The target resource represents a customer information control system (CICS) catalog software application for connecting CICS applications to external clients and servers. This target resource (e.g., CICS catalog software application) allows users to list items in a catalog, inquire on individual items in the catalog, and order items from the catalog.

The target resource includes: (1) a basic mapping support (BMS) manager 510, (2) a catalog manager 515, (3) a first data handler 520, (4) a second data handler 525 coupled to a catalog data store, (5) a first dispatch handler 530, (6) a second dispatch hander 535 coupled through a pipeline to order dispatch endpoints 545 and 550, and (7) a stock manager 540. In some embodiments, the components 510-550 represent software modules of the target resource.

Each of the above components 510-550 may be associated with one or more forms of digital data artifacts 555-590. For example, digital data artifact 555 includes descriptive information from a header comment relating to the BMS manager 510, digital data artifact 560 includes descriptive information from a header comment relating to the catalog manager 515, digital data artifact 565 includes descriptive information from a header comment relating to the first data handler 520.

In one embodiment, digital data artifact 570 includes descriptive information from a header comment relating to the second data handler 525, digital data artifact 575 includes descriptive information from a header comment relating to the first dispatch handler 530, digital data artifact 580 includes descriptive information from a header comment relating to the second dispatch handler 535, digital data artifact 585 includes descriptive information from a header comment relating to the stock manager 540, and digital data artifact 590 includes descriptive information from a header comment relating to the order dispatch endpoint 545.

In some embodiments, the digital data associated with artifacts 555-590 are contained within computer files stored on a storage media (e.g., magnetic disk, flash disk, optical disk, etc.). The digital data artifacts 555-590 may also include: programming code representing the computer instructions of the various software application components, documentation, testing materials, etc.

To identify the services performed by the components 510-550, the corresponding digital data artifacts 555-590 are populated within the repository. The clustering module of some embodiments processes the digital data artifacts 555-590 using one or more clustering algorithms to identify the clusters. In FIG. 5, the data elements of the digital data artifacts 555-590 belonging to the same cluster are denoted by different font demarcations (e.g., bolding, italicization, highlighting, underlining, bolding and underling, and bolding and italicization without detracting from the scope of the claims).

For example, the data elements “data store” and “VSAM file” of digital data artifact 565 and the data elements “VSAM Data Store,” “accesses,” “VSAM file,” and “reads and updates” of digital data artifact 570 are bolded and italicized. The bolding and italicization of each of these data elements pictorially represents that during cluster analysis, the clustering module has observed similarity between each of these data elements.

Therefore, the clustering module groups these data elements from the two different digital data artifacts 565 and 570 together into a single cluster, in accordance with one embodiment. The summarization module then processes the resulting clusters in order to generate a human or machine understandable descriptive summary for each cluster. Such descriptions may be processed by the service identification module to identify a service associated with each cluster or group of clusters.

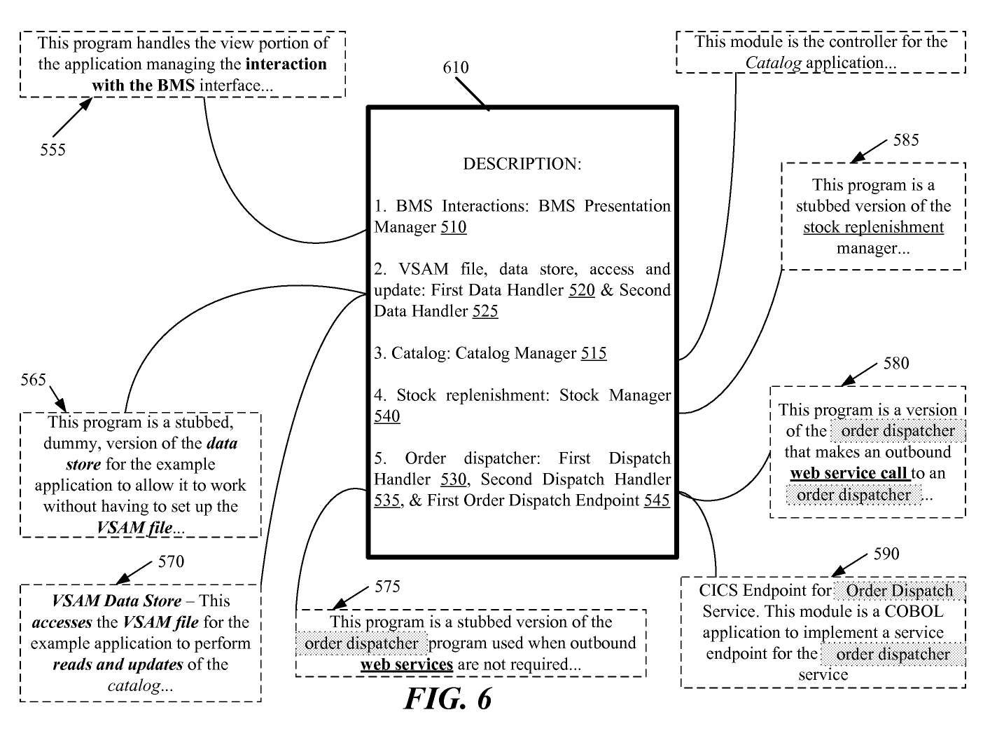

FIG. 6 illustrates an exemplary description 610 for the clusters that result from processing the digital data associated with the resource of FIG. 5, in accordance with one embodiment. In some embodiments, the description 610 is a text document that is generated and stored on a computing system. It is noteworthy that the description content may be stored in several alternative formats other than a text format. For example, the description content may include database records populating a database.

In this exemplary figure, the description 610 contains text summarizing the one or more services identified within each of the clusters resulting from the clustering of digital data artifacts 555-590. The description 610 omits any information (e.g., text) or other data elements that is deemed irrelevant by the summarization algorithm and retains or rewords the information (e.g., text) or data elements that are deemed relevant to identify the services provided by each component of the resource of FIG. 5. The description for all clusters 555-590 is presented within the description 610. However, it is noteworthy that the summarization module of some embodiments may generate a separate description file for each of the identified services or for each of the clusters.

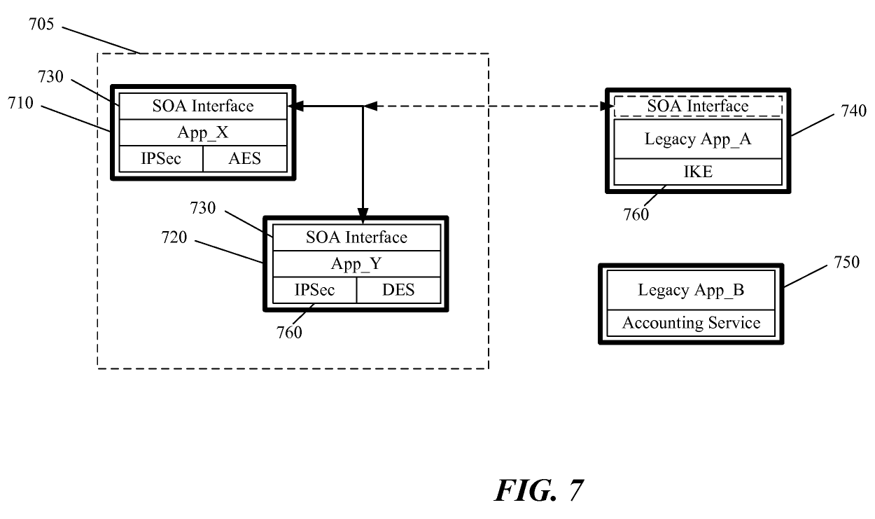

FIG. 7 conceptually illustrates how the descriptions generated by an exemplary embodiment facilitate integration of a software application into a distributed computing environment 705. In this figure, two software applications 710 and 720 are part of the distributed computing environment and each software application provides security/encryption services to the distributed computing environment. For example, software application 710 provides advanced encryption standard (AES) services and software application 720 provides data encryption standard (DES) services. The software applications 710 and 720 are able to communicate with each other because of a common interface 730. The common interface 730 is defined according to specifications of the distributed computing environment 705.

Software applications 740 and 750 do not utilize the common interface 730. Accordingly, software applications 740 and 750 are unable to access or exchange data with any of the services of the distributed computing environment 705.

The service identification system of some embodiments (e.g., the clustering module and the summarization module) processes the digital data associated with each of the software applications 740 and 750 to generate descriptions that describe the services of applications 740 and 750. From the generated descriptions, a user is able to determine that software application 740 provides a complimentary security/encryption service, internet key encryption (IKE). Also from the generated descriptions, a user is able to determine that software application 750 does not provide any complimentary security/encryption services.

Accordingly, the user may create a modified interface only for software application 740 such that its security/encryption services become interoperable with the other security/encryption services of the distributed computing environment 705. The modified interface for software application 740 will allow the existing services (e.g., IKE) to interoperate with the distributed computing environment 705 without having to recode or change the underlying functionality of the software application 740.

In different embodiments, the claimed subject matter may be implemented either entirely in the form of hardware or entirely in the form of software, or a combination of both hardware and software elements. For example, system 110 may comprise a controlled computing system environment that may be presented largely in terms of hardware components and software code executed to perform processes that achieve the results contemplated by the system of the claimed subject matter.

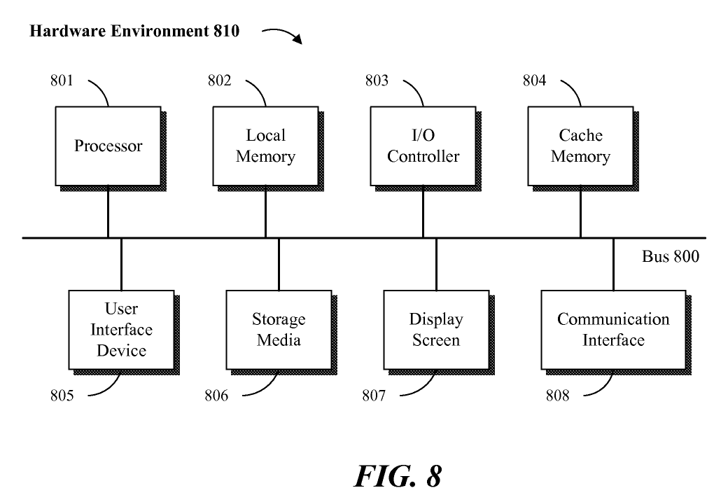

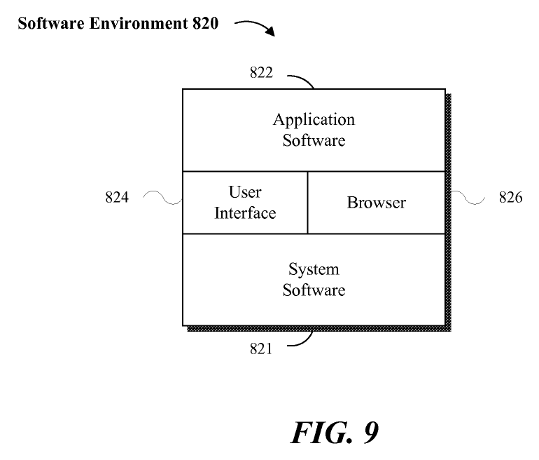

Referring to FIGS. 8 and 9, a computing system environment in accordance with an exemplary embodiment is composed of a hardware environment 810 (see FIG. 8) and a software environment 820 (see FIG. 9). The hardware environment 810 comprises the machinery and equipment that provide an execution environment for the software; and the software environment 820 provides the execution instructions for the hardware as provided below.

As provided here, software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 820 is divided into two major classes comprising system software 821 and application software 822. In one embodiment, one or more of the clustering module 210, the summarization module 220, or the service identification module 230 may be implemented as system software 821 or application software 822 executed on one or more hardware environments to identify services of software applications.

System software 821 may comprise control programs, such as the operating system (OS) and information management systems that instruct the hardware how to function and process information. Application software 822 may comprise but is not limited to program code, data structures, firmware, resident software, microcode or any other form of information or routine that may be read, analyzed or executed by a microcontroller.

In an alternative embodiment, the claimed subject matter may be implemented as computer program product accessible from a computer-usable or computer-readable medium providing program code for use by or in connection with a computer or any instruction execution system. For the purposes of this description, a computer-usable or computer-readable medium may be any apparatus that can contain, store, communicate, propagate or transport the program for use by or in connection with the instruction execution system, apparatus or device.

The computer-readable medium may be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and digital video disk (DVD).

Referring to FIG. 9, an embodiment of the application software 822 may be implemented as computer software in the form of computer readable code executed on a data processing system such as hardware environment 810 that comprises a processor 801 coupled to one or more memory elements by way of a system bus 800. The memory elements, for example, may comprise local memory 802, storage media 806, and cache memory 804. Processor 801 loads executable code from storage media 806 to local memory 802. Cache memory 804 provides temporary storage to reduce the number of times code is loaded from storage media 806 for execution.

A user interface device 805 (e.g., keyboard, pointing device, etc.) and a display screen 807 can be coupled to the computing system either directly or through an intervening I/O controller 803, for example. A communication interface unit 808, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 810 may not include all the above components, or may comprise other components for additional functionality or utility. For example, hardware environment 810 can be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In some embodiments of the system, communication interface 808 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 9, application software 822 may comprise one or more computer programs that are executed on top of system software 821 after being loaded from storage media 806 into local memory 802. In a client-server architecture, application software 822 may comprise client software and server software. For example, in one embodiment, client software is executed on system 605 and server software is executed on a server system (not shown).

Software environment 820 may also comprise browser software 826 for accessing data available over local or remote computing networks. Further, software environment 820 may comprise a user interface 824 (e.g., a Graphical User Interface (GUI)) for receiving user commands and data. Please note that the hardware and software architectures and environments described above are for purposes of example, and one or more embodiments may be implemented over any type of system architecture or processing environment.

It should also be understood that the logic code, programs, modules, processes, methods and the order in which the respective processes of each method are performed are purely exemplary. Depending on implementation, the processes can be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

The claimed subject matter has been described above with reference to one or more features or embodiments. Those skilled in the art will recognize, however, that changes and modifications may be made to these embodiments without departing from the scope of the claimed subject matter. These and various other adaptations and combinations of the embodiments disclosed are within the scope of the claimed subject matter as defined by the claims and their full scope of equivalents.

What is claimed is:

1. A computing system implemented method of identifying services performed by one or more computing resources, the method comprising:
analyzing digital data stored in at least one storage medium, the digital data associated with one or more computing resources to identify similarities between said digital data;
grouping sets of digital data into one or more clusters according to similarities identified between said digital data;
generating a description for each cluster to define a computational service associated with a set of digital data grouped in the cluster; and
defining a service for a set of clusters according to similarities identified between descriptions for said set of clusters.

2. The method of claim 1 further comprising selecting a set of conditions for identifying similarities between said digital data, wherein analyzing said digital data comprises identifying the similarities based on the selected set of conditions.

3. The method of claim 2, wherein said set of conditions define a clustering algorithm, and wherein selecting the set of conditions comprises selecting the clustering algorithm from a plurality of clustering algorithms.

4. The method of claim 3 further comprising receiving a set of constraints for specifying parameters of the clustering algorithm that determine similarity between said digital data.

5. The method of claim 1, wherein said digital data comprises program code.

6. The method of claim 5, wherein said digital data further comprises at least one of documentation, test data, and runtime generated data.

7. The method of claim 1, wherein said digital data comprises one or more data elements, and wherein grouping the sets of digital data into the one or more clusters comprises associating a set of the data elements to a cluster based on similarity amongst the set of the data elements.

8. The method of claim 1, wherein said digital data comprises one or more data elements, and wherein grouping the sets of digital data into the one or more clusters comprises associating a set of the data elements to a cluster based on structural similarity amongst the set of the data elements.

9. The method of claim 1, wherein said digital data comprises one or more data elements, and wherein grouping the sets of digital data into the one or more clusters comprises associating a set of the data elements to a cluster based on workload similarity amongst the set of the data elements.

10. The method of claim 1 further comprising identifying a type of the digital data from among a plurality of data types prior to analyzing said digital data.

11. The method of claim 10 further comprising selecting a clustering algorithm from among a plurality of clustering algorithms based on the identified type of the digital data, wherein grouping the digital data comprises grouping the digital data into each of the plurality of clusters according to the selected clustering algorithm.

12. The method of claim 1, wherein the set of clusters comprises one or more clusters.

13. The method of claim 1 further comprising receiving a set of constraints that specify a threshold for determining similarity between at least two generated descriptions before defining said service.

14. The method of claim 1, wherein said digital data comprises one or more data elements, the method further comprising receiving a set of constraints that define a threshold for grouping a data element to a particular cluster.

15. The method of claim 1 further comprising selecting a summarization algorithm, wherein generating said description comprises generating a description for each cluster based on the selected summarization algorithm.

16. The method of claim 1, wherein said analyzing, said grouping, said generating, and said defining are performed automatically by a computing system without human intervention.

17. The method of claim 1, wherein said computing system comprises a computing system of a distributed computing environment, said distributed computing system comprising a plurality of computing resources interoperating through a common communication interface.

18. The method of claim 1 further comprising defining a communication interface to establish inter-operability between the defined service associated with one or more computing resources of the computing system and at least one computational service associated with a different computing resource of a distributed computing environment.

19. The method of claim 18 further comprising applying said communication interface to the computing resources associated with the defined service without modifying underlying functionality of the computing resources.

20. A system for identifying services performed by one or more computing resources, the system comprising:
at least one storage medium for storing digital data associated with one or more computing resources;
a logic unit for grouping sets of digital data into one or more clusters according to similarities between said digital data;
a logic unit for generating a description for the one or more clusters to define at least one computational service associated with a set of digital data grouped in the one or more clusters; and
a logic unit for defining a service for a set of clusters according to similarities identified between descriptions for said set of clusters.

21. A computer program product comprising a computer useable medium having a computer readable program for identifying computational services performed by one or more computing resources, wherein the computer readable program when executed on a computer causes the computer to:
analyze digital data associated with one or more computing resources to identify similarities between said digital data;
group sets of digital data into one or more clusters according to similarities identified between said digital data;
generate a description for each cluster to define a computational service associated with a set of digital data grouped in the cluster; and
define a service for a set of clusters according to similarities identified between descriptions for said set of clusters.

22. A method of integrating a computing resource of a first computing system with computing resources of a distributed computing environment comprising a second computing system, the method comprising:
analyzing digital data stored in at least one storage medium, the digital data associated with a computing resource of the first computing system;
identifying at least one computational service performed by said computing resource based on the analysis of said digital data; and
defining a communication interface for establishing inter-operability between the identified computational service of the computing resource of the first computing system and a computational service associated with a computing resource of the second computing system.

23. The method of claim 22 further comprising coupling said communication interface to the computing resource of the first computing system, wherein said communication interface translates messages from a format specified for transmitting messages over the distributed computing environment to a format specified for processing of messages by the computing resource of the first computing system.

24. The method of claim 22 further comprising generating a description to describe said identified computational service.
